(19) United States
(12) Patent Application Publication
(10) Pub. No.: US 2009/0254849 A1
(43) Pub. Date: Oct. 8, 2009

(54) METHOD AND USER INTERFACE FOR THE GRAPHICAL PRESENTATION OF MEDICAL DATA

(76) Inventors: Karlheinz Glaser-Seidnitzer, Fuerth (DE); Johannes Kling, Zurich (CH); Martin Requardt, Nuernberg (DE)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/420,133

(22) Filed: Apr. 8, 2009

(30) Foreign Application Priority Data
Apr. 8, 2008 (DE) 10 2008 017 830.6

(51) Int. Cl. G06F 3/048

(52) U.S. Cl. 715/771

(57) ABSTRACT

Operation of a method and a device for the implementation of a medical examination via a user interface of at least one imaging device include determination and input of a group of measurement parameters via an input device of the user interface, generation of spatially resolved image information with the at least one imaging device depending on the group of measurement parameters, and storage of the image information on a storage medium and presentation of the image information as a data symbol on a screen of the user interface. Multiple data symbols are presented in a predetermined arrangement on the screen for a medical assessment. A UI element on the screen and a pointer symbol is positioned on the screen in one of the multiple data symbols via an input device. A predetermined region at the position of the pointer symbol is shown in the UI element.

### BACKGROUND OF THE INVENTION

1. Field of the Invention

The present invention concerns the graphical presentation of medical examination results that were acquired with imaging methods, and in particular a method and a user interface for the implementation of a medical examination.

2. Description of the Prior Art

In the implementation of imaging methods in medical technology (for example magnetic resonance tomography, computed tomography etc.), large sets (quantities) of data (radiological data sets) are regularly acquired. Various methods (known as browsers) are known from the prior art for the necessary consideration, processing and assessment of the acquired data. These browsers for radiological data sets allow the user (radiologist, MRTA) to view the representation of the data sets in detail views or context views.

The user interfaces of browsers for radiological data sets are typically designed for a specific user situation. For example, in the browsers it is possible to show specific regions enlarged (detail view) by section enlargement (zooming) in a corresponding image segment of a data set. In specific situations, however, a complete view of the entire data set can better show the necessary information (context view). A change between detail view and context view can occur repeatedly in succession. In the browsers known in the prior art, either a detail information or a context information determined by corresponding section enlargement is therefore presented. A simultaneous presentation of detail view and context view is not possible.

The access or the presentation of the detail view and a context view thus can be done only in serial interactions, i.e. in succession, and is associated with relatively high cognitive effort and time by the user.

A system and method for dynamic configuration of the presentation at a workstation computer are known from EP 1 764 686 A1. A number of presentations as well as their resolution are automatically detected. An application window is set up for each presentation, which application window can be opened and closed without affecting other application windows. Moreover, a display protocol for each application window is complied with for the presentation of data in said window.

A computer and method for processing and/or evaluation of a digital image are known from DE 103 24 698 A1. The computer has an input device to detect a movement of the hand as well as a display device to display a display element. The display element has an element for the display of the position of a point; storage means are present that store the position after selection by the user; and program means are provided that provide the stored position for the further processing.

### SUMMARY OF THE INVENTION

An object of the invention is to provide a user interface of a browser for radiological data sets or data objects with which the data of a patient (images/series/3D data sets) that are acquired in imaging methods are clearly presented on a screen such that they can be easily and expeditiously accessed and manipulated.

The basis ideas of the invention is to expand the browser for presentation of the radiological data sets and data objects by at least one presentation possibility (UI element, user interface element), so that multiple presentations are simultaneously accessible and it is possible to change between the multiple presentations with little effort.

The above object is achieved by a method according to the invention for the implementation of a medical examination via a user interface of at least one imaging device that includes the steps of determination and input of a group of measurement parameters via an input device of the user interface, generation of spatially resolved image information with the at least one imaging device depending on the group of measurement parameters, storage of the image information on a storage medium; and/or presentation of the image information as a data symbol on a screen of the user interface. Multiple data symbols are presented in a predetermined arrangement on the screen for a medical assessment. A UI element is presented on the screen and a pointer symbol is movable on the screen in one of the multiple data symbols via an input device, with a predetermined region at the position of the pointer symbol being shown in the UI element.

One or more of the following features can be advantageously realized in embodiments of the method:
variation of the presentation scope of the region shown in the UI element by manipulation of the input device,
activation of the UI element via manipulation of the input device,
variation of the shape and dimensions of the UI element,
variation of the position of the UI element on the screen.

A device according to the invention for the implementation of a medical examination has at least one imaging device for the generation of spatially resolved image information depending on at least one measurement parameter, a storage medium for the storage of the image information thereupon; and/or a screen for the presentation of the image information as a data symbol thereupon. Multiple data symbols are shown in a predetermined arrangement on the screen for a medical assessment. A control unit is configured to cause the presentation of a region of a selected data symbol in a UI element on the screen so that, upon a positioning of a pointer symbol on the screen in one of the multiple data symbols using an input device, a predetermined region at the position of the pointer symbol is presented in the UI element.

An advantage of the invention is that detail and context information can be presented simultaneously. This reduces the cognitive effort for the user, and also reduces the time needed for evaluation and assessment since no switching between the views need occur. Such a mode of operation accommodates visually oriented people. The presentation can be adapted without further measures to various diagnostic questions; the screen space can always be optimally utilized.

The present invention also encompasses a computer-readable medium encoded with programming instructions, said medium being loadable into, or accessible by, a computer of a medical imaging device to cause the computer to operate the medical imaging device according to all of the embodiments of the method described above.

### BRIEF DESCRIPTION OF THE DRAWINGS

FIG. 1 schematically shows the design of an embodiment of the user interface according to the invention,

FIG. 2 schematically shows an example for a display on the user interface according to the invention and

FIGS. 3 and 4 show additional examples for the presentation according to the invention of patient information on the screen of a user interface according to the invention.

### DESCRIPTION OF THE PREFERRED EMBODIMENTS

The presentation in the figures is not to scale; identical elements or elements having identical effects are provided with the same reference characters.

The user interface according to the invention utilizes the possibilities of the display of an additional element of the user interface (known as a “UI element”) which can be superimposed on the original view. Via this additional element of the user interface, the user now has the possibility to receive context information as usual as well as to simultaneously receive detail information of the data object in the UI element.

The region of a data object that is focused on by the user can be enlarged or, respectively, reduced in the UI element. The factor of the enlargement can be continuously adjustable. The selection of the region of the data object to be shown in the UI element can by conducted by the user with the assistance of corresponding input devices. The position of the UI element on the screen is freely definable; the UI element can also be entirely masked out. It is also possible to freely select the shape of the UI element without this needing to have an effect on the content shown in the UI element.

The realization of this technical teaching is explained in the following with the figures.

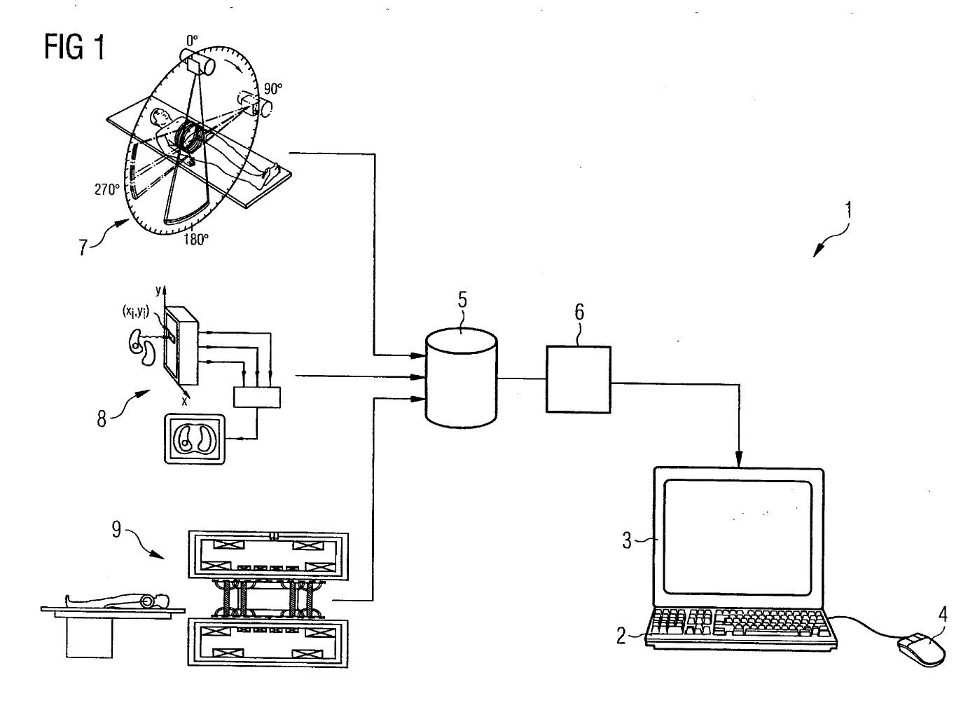

FIG. 1 shows an embodiment of the user interface 1 according to the invention. The user interface 1 has an input device 2 for selection by the user of the data objects to be presented. The selected data objects are displayed on a screen 3 of the user interface. The user is assisted in the selection of the data objects to be presented by an electromechanical transducer (for example what is known as a computer mouse 4 or a trackball, not shown). Other suitable input devices are, for example, a touchpad, an optical mouse, an eye tracker.\, etc.

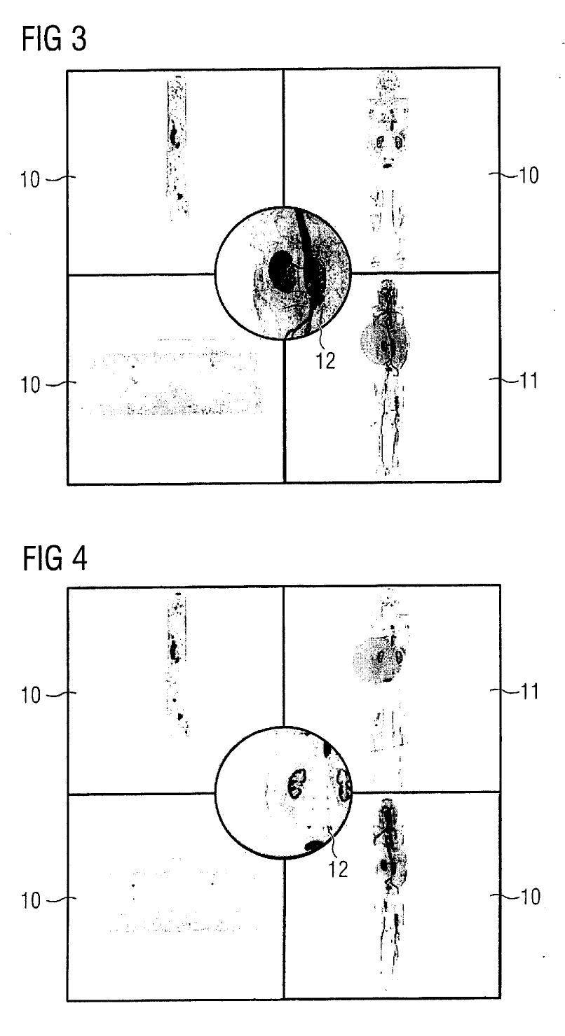

For a display function of the user interface 1, data or data objects are retrieved from a storage medium 5 and then displayed on the screen 3. The display is controlled by a special control device 6 in accordance with the invention. The presentation of objects on the screen 3 is explained further below using FIGS. 3 and 4.

The data on the storage medium 5 that are displayed on the screen 3 at an arbitrary point in time were acquired with one of three imaging methods and are present as a result of a computer tomography (CT) acquisition 7, or as a result of a positron emission tomography (PET) acquisition 8, or as a result of a magnetic resonance (MR) acquisition 9. Two methods can thereby also be combined with one another, for example PET and CET into PET-CT.

The data from one or more of the imaging methods 7, 8, 9 indicated in FIG. 1 are displayed on the screen 3. The display depends on preset display parameters. These display parameters can basically be selected independently; their number is also not predetermined in advance.

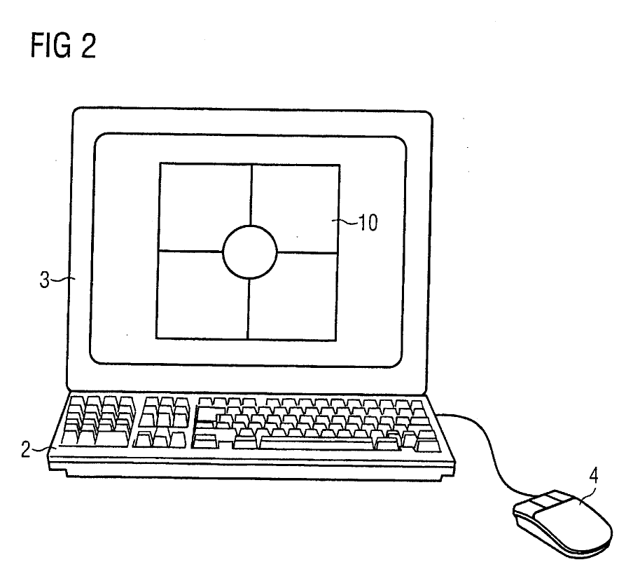

A first example for the display of data objects that are stored on the storage medium 5 is shown in FIG. 2. Four different data objects can be displayed in the four quadrants (top left, top right, bottom left, bottom right). These data objects can have been generated with one or more of the imaging methods 7, 8, 9 indicated in FIG. 1. If the data objects were generated with a single one of the indicated imaging methods 7, 8, 9, the data objects can have been generated with different parameters, or the data objects are presented with different display parameters.

For example, the different display parameters can correspond to the different slice planes in one of the aforementioned imaging methods. Four different slice planes can thus be presented and compared in the four quadrants. One of the four quadrants can be selected via an input device 4. A pointer symbol 13 on the screen can subsequently be positioned at a desired point within the selected quadrant with the aid of the input device 4. The region around the pointer symbol 13 is then shown enlarged in a UI element 12. The UI element 12 in this embodiment is shown at the intersection point of the four quadrants. The UI element 12 can be interactively manipulated by the user via the input device 4 or the keyboard 2.

The interactive manipulation of the UI element 12 can exist in that the position of the UI element 12 on the screen 3 is altered. The UI element 12 can be freely positioned on the entire presentation are available on the screen 3. The UI 12 can also be shown and hidden by the user via the input device 4 or the keyboard 2.

It is likewise possible to change the shape and/or size of the UI element 12. In the examples the UI element 12 is essentially circular. Other shapes are also possible, for example triangular, rectangular or n-sided shapes.

The size of the UI element 12 can also be varied. The size of the UI element 12 can occupy 0%-50% of the display area available on the screen 3 (advantageously 10%-40%, more advantageously 20%-30%, more advantageously 25%).

The region around the pointer symbol 13 that is presented enlarged in the UI element 12 can be varied. A reduction of the region around the pointer symbol 13 results in an enlargement of the presentation in the UI element 12 (increase of the zoom factor), and an enlargement of the region around the pointer symbol 13 results in a reduction of the presentation in the UI element 12 (decrease of the zoom factor). The variation of the zoom factor can occur in steps or continuously. The variation of the zoom factor can be conducted by the user via the input device 4 or the keyboard 2.

In another example, the various display parameters correspond to the three spatial coordinates, for example. In this case, for example, the exposure of a brain (acquired with the PET method 8, for example) in a sagittal view (bottom left), in a transaxial view (top right) and in a coronal view (top left) is presented as a data symbol 10 on the screen 3 of the user interface.

An embodiment is explained in the following using FIGS. 3 and 4. The screen 3 of the user interface 1 is respectively presented in FIGS. 3 and 4. Image sequences that were acquired with a specific imaging method are shown in FIG. 3. The sequences of images can include arbitrarily many individual parameters; here four images are shown as data symbols 10, 11 that should be differentiated depending on the survey parameters (i.e. one or more measurement parameters). For example, the survey parameters can indicate the height of the viewing plane along the body axis. Alternatively, exposures can have been produced after the administration of different medicines. Such a series of exposures is indicated here by four images, wherein these can naturally be more or fewer than four images. The cited survey parameter is not explicitly shown in the figures; but it is understood that it is the central measurement parameter for the medical analysis of the image information.

With the use of a pointer symbol 13 on the screen, the user can make a selection with regard to the additional data symbol 11 to be assessed. If a data symbol/image was selected, the region around the pointer symbol 13 is shown enlarged in a UI element 12. The UI element 12 in FIG. 3 is arranged in the middle of the data symbol 10. If the pointer symbol 13 moves within the selected data symbol 11, the region shown in the UI element 12 also varies.

The data symbols 10 move into the background relative to the selected data symbol 11 to be assessed. This can be achieved via a contrast change of the data symbols 10 relative to the data symbol 11 to be assessed or (as in FIG. 3) in that the data symbol 11 (bottom right) to be assessed is provided with a border, in contrast to the other three data symbols 10.

The same data symbols 10 as in FIG. 3 are shown in FIG. 4. However, in contrast to FIG. 3 the data symbol 10 (top right) is selected as a data symbol 11 to be assessed. The region around the pointer symbol 13 is shown again in the UI element 12.

Depending on how large the region around the pointer symbol 13 is selected, the scale of the image information shown in the UI element 12 also varies. The smaller the region around the pointer symbol 13, the larger the enlargement factor in the UI element 12.

A method and a device were described for implementation of a medical examination via a user interface of at least one imaging device, including determination and input of a group of measurement parameters via an input device of the user interface, generation of spatially resolved image information with the at least one imaging device depending on the group of measurement parameters and storage of the image information on a storage medium. The image information is presented as a data symbol on a screen of the user interface. Multiple data symbols are presented in a predetermined arrangement on the screen for a medical assessment and a selection of one data symbol is made from the multiple data symbols and/or presentation of a UI element on the screen, wherein a region of the selected data symbol is shown in the UI element.

The aforementioned embodiments can be implemented as software modules and/or hardware modules in the corresponding function blocks. The present invention is not limited to the aforementioned embodiments, but rather can be applied in other methods and devices for the implementation of a medical examination via a user interface.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for implementing a medical examination via a user interface of an imaging device, comprising the steps of:
determining a group of measurement parameters for implementing a medical examination with an imaging device, and entering said group of measurement parameters into the imaging device via an input device of a user interface of the medical imaging device;
in the medical imaging device, generating spatially resolved image information dependent on said group of measurement parameters, and storing said spatially resolved image information on a storage medium;
accessing said spatially resolved image information from said storage medium and presenting said image information as a data symbol on a screen of the user interface;
on said screen, presenting multiple data symbols in a predetermined arrangement for a medical assessment;
presenting a user interface element on said screen; and
positioning a pointer symbol on said screen in one of said multiple data symbols via said input device, with a predetermined region at the position of the pointer symbol being shown in said user interface element.

2. A method as claimed in claim 1 comprising allowing manipulation, via said input device, of a presentation scope of said region shown in said user interface parameter.

3. A method as claimed in claim 1 comprising activating said user interface element by manipulation of said input device.

4. A method as claimed in claim 1 comprising varying a shape and dimensions of said user input element via said input device.

5. A method as claimed in claim 1 comprising varying a position of said user interface element on said screen via said input device.

6. A user interface of a medical imaging device, comprising:
a processor that operates a medical imaging device;
an input unit allowing determination of a group of measurement parameters for implementing a medical examination with the medical imaging device, and entry of said group of measurement parameters into said processor;
said processor being configured to generate spatially resolved image information dependent on said group of measurement parameters;
a storage medium at which said spatially resolved image information is stored;
a display having a displace screen;
said processor being configured to access said spatially resolved image information from said storage medium and to present said image information as a data symbol on said display screen and to present multiple data symbols in a predetermined arrangement on said display screen for a medical assessment;
said processor being configured to present a user interface element on said display screen and to allow positioning of a pointer symbol on said display screen in one of said multiple data symbols via said input device, with a predetermined region at the position of the pointer symbol being shown in said user interface element.

7. A device as claimed in claim 6 wherein said input device is configured to influence a position of said pointer symbol on said screen to select one of said multiple data symbols, and wherein a presentation scope of said user interface element is selected by manipulation of said input device.

8. A computer-readable medium encoded with programming instructions for implementation of a medical examination via a computerized user interface of an imaging device, said programming instructions operating said user interface by:
allowing a group of measurement parameters for implementing a medical examination with an imaging device to be entered into a processor of the user interface via an input device of the user interface;
generating spatially resolved image information in the processor dependent on said group of measurement parameters, and storing said spatially resolved image information on a storage medium;
accessing said spatially resolved image information from said storage medium and presenting said image information as a data symbol on a screen of the user interface;
on said screen, presenting multiple data symbols in a predetermined arrangement for a medical assessment;
presenting a user interface element on said screen; and
allowing positioning of a pointer symbol on said screen in one of said multiple data symbols via said input device, with a predetermined region at the position of the pointer symbol being shown in said user interface element.
